(19) United States
(12) Patent Application Publication
(10) Pub. No.: US 2014/0317568 A1
(43) Pub. Date: Oct. 23, 2014

(54) INFORMATION PROCESSING APPARATUS, INFORMATION PROCESSING METHOD, PROGRAM, AND INFORMATION PROCESSING SYSTEM

(71) Applicant: SONY CORPORATION, TOKYO (JP)

(72) Inventor: HIROYUKI MIZUNUMA, Tokyo (JP)

(73) Assignee: SONY CORPORATION, TOKYO (JP)

(21) Appl. No.: 14/230,344

(22) Filed: Mar. 31, 2014

(30) Foreign Application Priority Data
Apr. 22, 2013 (JP) 2013-089297

(51) Int. Cl. G06F 3/0482

(52) U.S. Cl. CPC G06F 3/0482
USPC 715/813

(57) ABSTRACT

There is provided an information processing apparatus including a detecting unit configured to detect a plurality of selection operations with respect to an object displayed on a display screen, and a deciding unit configured to decide an object that a user is to select, based on the plurality of selection operations.

### CROSS REFERENCE TO RELATED APPLICATIONS

This application claims the benefit of Japanese Priority Patent Application JP 2013-089297 filed Apr. 22, 2013, the entire contents of which are incorporated herein by reference.

### BACKGROUND

The present disclosure relates to an information processing apparatus, an information processing method, a program, and an information processing system.

In recent years, apparatuses provided with touch panels, such as mobile devices like smartphones, are commonly used. For example, as disclosed in JP 2012-043266A, with an apparatus provided with a touch panel, a user can view a desired web page, content, and the like by tapping a GUI object of a link to the web page or the like, with a finger.

### SUMMARY

However, in an apparatus provided with a touch panel, it is difficult to select a small GUI object by tapping, and erroneous selection such as selection of a GUI object that is adjacent to a desired GUI object can be generated. In particular, the erroneous selection tends to be generated markedly in a state where GUI objects are crowded. Further, since a small mobile device such as a smartphone has a limited size of a display screen, the size of the GUI object is further downsized and it is more difficult to select the GUI object by tapping.

Thus, in general, a target GUI object is enlarged by enlarging the display screen and then the GUI object is selected. With this method, in order to select the GUI object, an operation including two different stages, i.e., enlarging the screen and tapping the GUI object, is necessary.

Further, as an operation to enlarge the screen, a pinch operation is most common for a touch panel device; however, a plurality of fingers are necessary for the pinch operation, with one hand holding the device and with the other hand performing the pinch operation. In contrast, since the tap operation needs only one finger, the tap operation can be performed with one hand holding the device. Therefore, unfortunately, in a case where the GUI object is enlarged and is then selected, the user cannot finish the pinch operation and the tap operation with one hand.

Thus, it is demanded that, even in a case where a small GUI object is displayed, a desired GUI object can be selected surely.

According to an embodiment of the present disclosure, there is provided an information processing apparatus including a detecting unit configured to detect a plurality of selection operations with respect to an object displayed on a display screen, and a deciding unit configured to decide an object that a user is to select, based on the plurality of selection operations.

Further, a counting unit configured to count a number of times a specific object is selected by the selection operations may be further included, and the deciding unit may decide the object that the user is to select, based on the number of times counted by the counting unit.

Further, the deciding unit may decide, as the object that the user is to select, an object whose number of times counted in a certain period of time is largest.

Further, the deciding unit may decide, as the object that the user is to select, an object whose number of times counted reaches a predetermined value earliest.

Further, the deciding unit may decide, as the object that the user is to select, an object at a position closest to an average of coordinates of the plurality of selection operations.

Further, the deciding unit may decide, as the object that the user is to select, an object that is selected consecutively a predetermined number of times or more.

Further, a mode releasing unit configured to release a mode in which an object is decided based on the plurality of selection operations to return to a normal mode in which an object is decided based on a one-time selection operation may be further included.

Further, the mode releasing unit may release the mode in a case where the selection operations are not performed in a certain period of time.

Further, the mode releasing unit may release the mode in a case where an operation other than the selection operations is performed.

Further, the mode releasing unit may release the mode in a case where an operation is performed at a position away from a coordinate center of the plurality of selection operations by a predetermined distance or more.

Further, a display processing unit configured to perform processing for displaying the object on the display screen may be further included, and the display processing unit may change a display state of the object that is specific, in accordance with an increase in number of times the specific object is selected.

Further, the deciding unit may decide the object that the user is to select, by weighting, among the plurality of selection operations, a first selection operation highly compared with other selection operations.

According to another embodiment of the present disclosure, there is provided an information processing method including detecting a plurality of selection operations with respect to a given object on a display screen, and deciding an object that a user is to select, based on the plurality of selection operations.

According to another embodiment of the present disclosure, there is provided a program causing a computer to execute detecting a plurality of selection operations with respect to a given object on a display screen, and deciding an object that a user is to select, based on the plurality of selection operations.

According to another embodiment of the present disclosure, there is provided an information processing system including a first device configured to detect an operation of a user, and a second device including a detecting unit configured to detect a plurality of selection operations with respect to a given object on a display screen by acquiring operation information of the user from the first device, and a deciding unit configured to decide an object that the user is to select, based on the plurality of selection operations.

According to one or more of embodiments of the present disclosure, even in a case where a small object is displayed on a display screen, it becomes possible to select a desired object surely.

### BRIEF DESCRIPTION OF THE DRAWINGS

FIG. 1 is a schematic diagram showing an overall configuration of an information processing apparatus according to an embodiment of the present disclosure;

FIG. 2 is a block diagram showing functions of a CPU;

FIG. 3 is a schematic diagram showing a specific example of a consecutive tap operation according to the present embodiment;

FIG. 4 is a schematic diagram showing a state in which a link is selected;

FIG. 5 is a schematic diagram showing a state in which a link is selected;

FIG. 6 is a schematic diagram showing a processing procedure in an information processing apparatus; and

FIG. 7 is a schematic diagram showing a system with a pointing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that a description will be given in the following order.

1. Configuration example of apparatus

2. Specific example of plurality of consecutive taps

3. Processing procedure in information processing apparatus

4. Cancelation of consecutive tapping selection mode

5. Operation other than operation in touch panel device

6. Graphic animation

### 1. Configuration Example of Apparatus

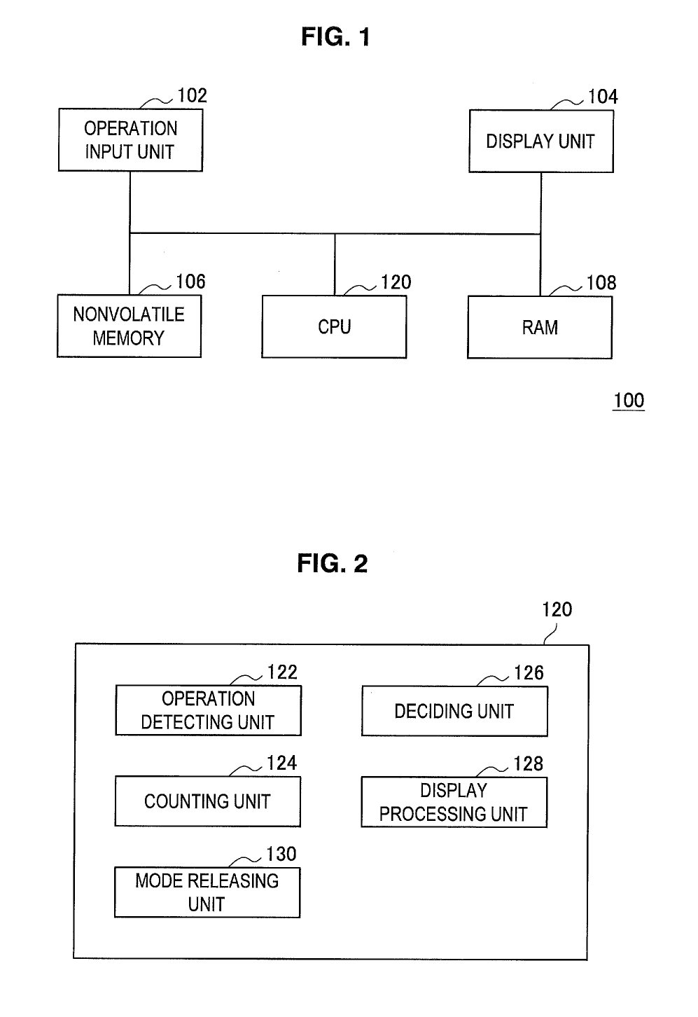

First, an overall configuration of an information processing apparatus 100 according to an embodiment of the present disclosure will be described with reference to FIG. 1. As an example, the information processing apparatus 100 is a mobile device such as a smartphone. As shown in FIG. 1, the information processing apparatus 100 includes an operation input unit 102, a display unit 104, nonvolatile memory 106, RAM 108, and a CPU 120.

In this embodiment, the operation input unit 102 is a capacitive touch sensor and detects a touch or approach of a finger of a user by a change in electrostatic capacitance. In this embodiment, the operation input unit 102 is disposed to be superposed on the display unit 104, so that a touch panel is configured by the operation input unit 102 and the display unit 104. Note that the touch sensor may be any touch sensor but the capacitive touch sensor as long as the touch or approach of the finger of the user can be detected. Further, the operation input unit 102 may be a device such as a mouse or a keyboard.

The display unit 104 is configured by, for example, a liquid crystal display (LCD) and displays a specified web page, content, and the like in accordance with a user's operation on the operation input unit 102. The nonvolatile memory 106 is memory that stores data, software, and the like. The RAM 108 is memory that temporarily stores data of content displayed on the display unit 104, for example.

The CPU 120 is a control unit that entirely controls the information processing apparatus 100 and functions as each structural element shown in FIG. 2 by executing a program stored in the nonvolatile memory 106.

FIG. 2 is a block diagram showing functions of the CPU 120. As shown in FIG. 2, the CPU 120 functions as an operation detecting unit 122, a counting unit 124, a deciding unit 126, a display processing unit 128, and a mode releasing unit 130 by executing a program (software) stored in the nonvolatile memory 106. Note that the structural elements shown in FIG. 2 may be configured by hardware (circuit).

Upon receiving a detection signal from the operation input unit 102, the operation detecting unit 122 detects which position of the operation input unit 102 at which the user's finger has touched. The counting unit 124 counts the number of times of touches in a case where the operation detecting unit 122 detects that the user's finger touches (taps) a position of the same GUI object of the operation input unit 102.

The deciding unit 126 decides a GUI object that the user is to select, based on a plurality of the taps detected by the operation detecting unit 122. Specifically, the deciding unit 126 decides the GUI object that the user is to select, based on the counted number of taps detected by the counting unit 124. Further, the deciding unit 126 decides a GUI object that is closest to a coordinate center as the GUI object that the user is to select, based on the coordinate center in the coordinates of the plurality of taps detected by the operation detecting unit 122.

The display processing unit 128 performs processing to display, on the display unit 104, a link of the GUI object decided by the deciding unit 126. The mode releasing unit 130 performs processing to release a consecutive tapping selection mode to return to a normal mode in a case where predetermined conditions are satisfied.

### 2. Specific Example of Plurality of Consecutive Taps

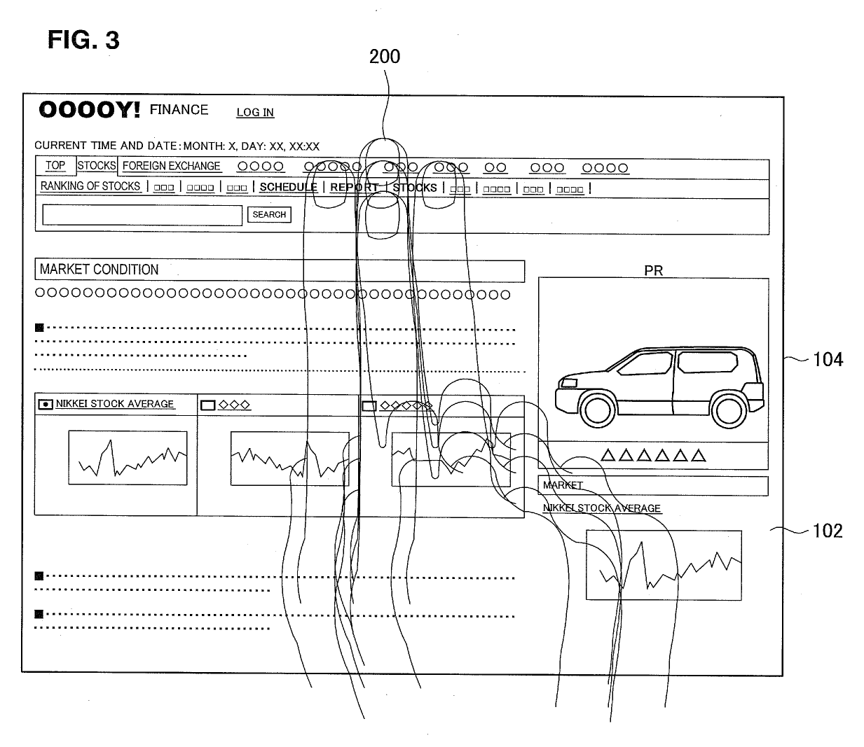

Next, a specific example of a consecutive tap operation according to this embodiment will be described with reference to FIG. 3. First, a user performs a predetermined operation on the operation input unit 102, thereby switching a mode from the normal mode to the consecutive tapping selection mode. Here, the normal mode refers to a mode in which a GUI object is selected by a normal one-time tap. As described above, in the normal mode, there can be erroneous selection in a case where the GUI object is small.

The consecutive tapping selection mode refers to a mode in which a user taps the operation input unit 102 plural times and a GUI object that has been tapped plural times is selected.

FIG. 3 shows a state in which, after the mode is switched to the consecutive tapping selection mode, consecutive tapping input is performed plural times with respect to a target GUI object. The example in FIG. 3 shows a state in which a finger 200 of the user selects a link represented as “REPORT” that is the GUI object.

The user taps consecutively the link “REPORT”, which is the target GUI object, and the periphery thereof plural times. At this time, in this embodiment, a GUI object that has been tapped most frequently or largest number of times is selected.

Here, as a method for deciding the GUI object that the user is to select, based on whether the user taps the GUI object “frequently” or “largest number of times”, the following three variations will be shown.

In a first method, a GUI object that has been tapped largest number of times in a certain period of time counted from a first tap after the mode has been switched to the consecutive tapping selection mode is decided. The certain period of time is, for example, about 500 ms to several seconds long. In a second method, a GUI object whose number of taps reaches a predetermined number of taps earliest, the number being counted from a first tap after the mode has been switched to the consecutive tapping selection mode, is decided. The predetermined number of taps is, for example, about three to five. In a third method, a GUI object that is closest to the coordinate center of coordinates of taps in a certain period of time counted from a first tap after the mode has been switched to the consecutive tapping selection mode is decided.

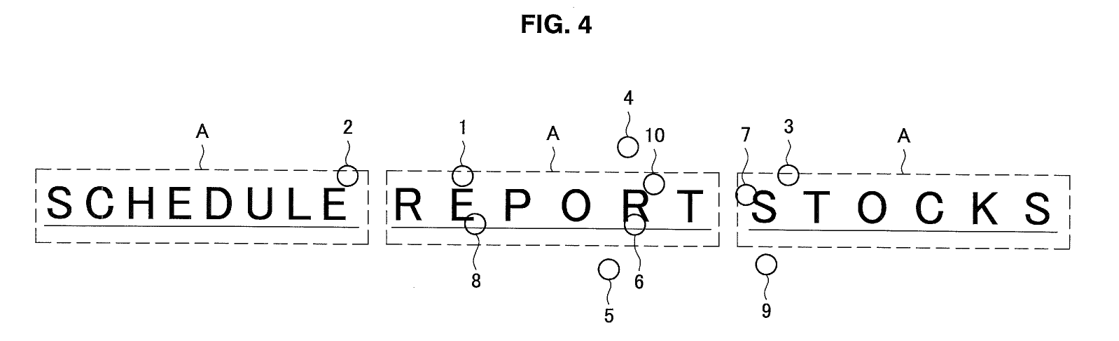

FIG. 4 is a schematic diagram showing a state in which the link “REPORT” is selected by the first or second method. In FIG. 4, the link “REPORT” is shown together with links “SCHEDULE” and “STOCKS”, which are adjacent to the link “REPORT” in the left and right direction. In FIG. 4, circles each represent a position (coordinate) at which the user has tapped, and numbers attached to the circles each represent the order of taps. Further, dotted lines surrounding “REPORT”, “SCHEDULE”, and “STOCKS” each represent an area A where taps with respect to each GUI object are detected. When the coordinate of the position at which the user has tapped with the finger 200 is within the area A, a tap with respect to a GUI object that is relevant in the area is detected. The operation detecting unit 122 detects the tap.

In a case where the GUI object is selected by the first method, as shown in FIG. 4, ten taps in total are assumed to have been performed in a certain period of time, for example. In this case, since the first, sixth, eighth, and tenth taps are located within the area A, four taps in total are performed in the link “REPORT”. On the other hand, one tap in total is performed in the link “SCHEDULE” and two taps in total are performed in the link “STOCKS”. Therefore, it is decided to select the link “REPORT” where the number of taps in a certain period tome is the largest. The number of taps on each link is counted by the counting unit 124. Further, the selection of the link “REPORT” is decided by the deciding unit 126 based on the results of counting by the counting unit 124.

Further, in a case where a GUI object is to be selected by the second method, as shown in FIG. 4, ten taps in total are assumed to have been performed, for example. When the predetermined number of taps is four times, for example, the first, sixth, eighth, and tenth taps are located within the area A in the link “REPORT”. Thus, by performing the tenth tap, the number of taps on the link “REPORT” reaches four. Therefore, it is decided to select the link “REPORT” whose number of taps reaches the predetermined number of taps earliest, the number being counted from the first tap.

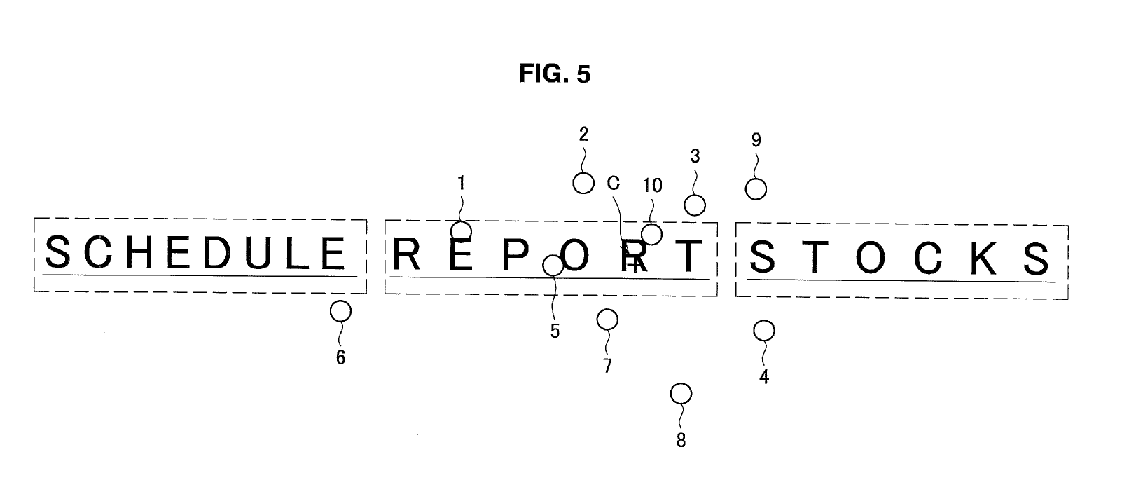

FIG. 5 is a schematic diagram showing a state in which the link “REPORT” is selected by the third method. As shown in FIG. 5, ten taps in total are assumed to have been performed in a certain period of times, for example. A coordinate center C of the ten taps is located within the area A of the link “REPORT”. Therefore, it is decided to select the link “REPORT”, which is the GUI object closest to the coordinate center C of coordinates of taps in a certain period of time. In this case, the deciding unit 126 decides that the link “REPORT”, which is closest to the coordinate center, is selected by the user based on the coordinate center C of coordinates of the plurality of taps detected by the operation detecting unit 122.

In the first method, the “certain period of time” may be changed by being input by the user from the operation input unit 102. Further, in the second method, the “predetermined number of taps” may be changed by being input by the user from the operation input unit 102. Thus, the user can adjust a trade-off relation between the time to select a GUI object (or the number of taps) and erroneous selection.

In the method for selecting the GUI object in this embodiment, “easiness to select a GUI object” and “generation rate of erroneous selection” is in a trade-off relation. In a case where the “certain period of time” or the “predetermined number of taps” is decreased in order to make the selection easier, the “generation rate of erroneous selection” increases. Thus, a user who is well-accustomed to selecting a GUI object by tapping and is unlikely to generate erroneous selection can shorten the time to select the GUI object by setting the “certain period of time” or the “predetermined number of taps” to a small value.

Further, when a selected GUI object is to be decided, the respective GUI objects may be weighted. For example, in the first method, since it is assumed that the first tap may be performed carefully by the user, the GUI object that is tapped for the first time may highly possibly be the GUI object that the user is to select. Thus, a plurality of tapping times may be added to the GUI object that is tapped for the first time, at the time when the first tap is performed. The same can be applied to the second method.

Referring to the example shown in FIG. 4, since the GUI object that is tapped for the first time is the link “REPORT”, the first tap is counted as the third tap, for example. Thus, the GUI object that is tapped for the first time can be weighted highly.

Further, as a fourth method, in a case where the same GUI object is tapped consecutively plural times, for example, it is possible to select a GUI object that is highly possibly regarded as a selected GUI object from an operation history up to the present. For example, in the example shown in FIG. 4, in a case where the link “REPORT” is tapped consecutively three times, the link “REPORT” may be decided as the selected GUI object. Thus, it is possible to select immediately the GUI object that is the selected GUI object most possibly, based on the number of consecutive taps.

### 3. Processing Procedure in Information Processing Apparatus

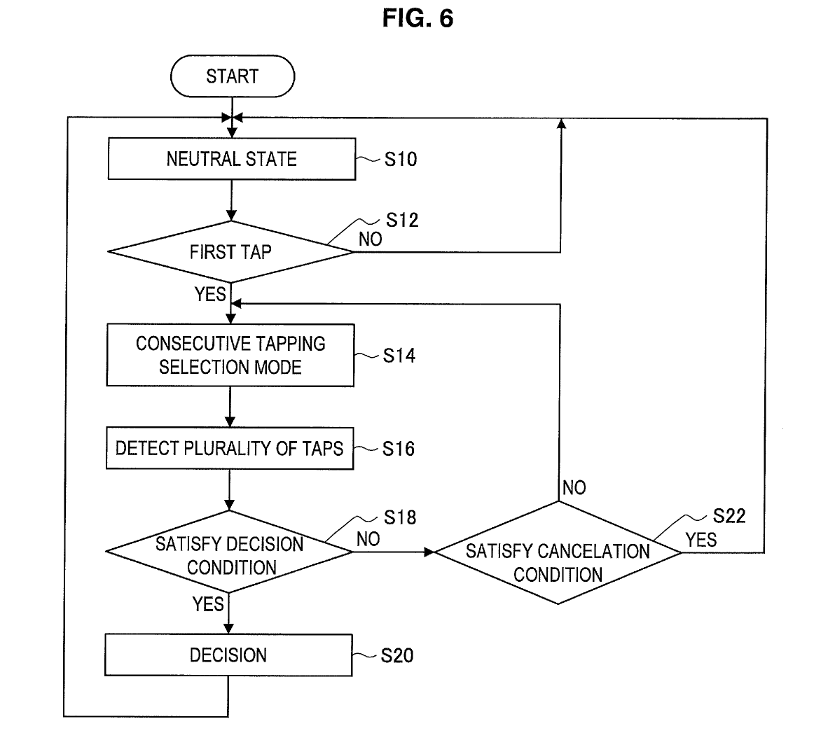

Next, a processing procedure in an information processing apparatus will be described with reference to a flow chart shown in FIG. 6. Here, an example will be described in which the mode is switched to the consecutive tapping selection mode by the first tap. The user taps the display screen of the display unit 104 one time, thereby switching the mode from the normal mode to the consecutive tapping selection mode. The switching to consecutive tapping selection mode can be performed by, for example, the user tapping a button in a predetermined position on the display screen or operating a predetermined hardware key.

First, in step S10, an information processing apparatus 100 is set to be in a neutral state (the normal mode). Next, in step S12, it is determined whether or not the first tap for switching the mode is performed. In a case where the first tap is performed, the procedure moves on to step S14; in a case where the first tap is not performed, the procedure returns to the step S10.

In step S14, owing to the first tap, the mode is switched to the consecutive tapping selection mode. Next, in step S16, a plurality of taps performed by the user are detected. Next, in step S18, by any of the above-described first to fourth methods, it is determined whether or not decision conditions for selection of the GUI object are satisfied. In a case where the decision conditions are satisfied in step S18, the procedure moves on to step S20. In step 20, the selected GUI object is decided.

On the other hand, in a case where the decision conditions are not satisfied in step S18, the procedure moves on to step S22. In step S22, it is determined whether or not cancelation conditions are satisfied by a later-described method. In a case where the cancelation conditions are satisfied, the procedure returns to step S10 and the neutral state (the normal mode) is set again. In a case where the cancelation conditions are not satisfied, the process returns to step S14, and a plurality of taps are detected in the consecutive tapping selection mode in the subsequent processing.

### 4. Cancelation of Consecutive Tapping Selection Mode

Next, cancelation of a consecutive tapping selection mode will be described. In the consecutive tapping selection mode, the consecutive tapping selection mode can be canceled to move on to the neutral state. Here, the following four methods will be shown as examples of cancelation methods.

In a first method, in operation with the consecutive tapping selection mode, in a case where a tap operation is not performed for a certain period of time, the consecutive tapping selection mode is canceled. In a second method, in operation with the consecutive tapping selection mode, in a case where a touch gesture operation (including a pinch operation, a swipe operation, and a multi-touch gesture) other than the tap operation is not performed for a certain period of time, or in a case where a key operation, for example, is not performed, the consecutive tapping selection mode is canceled. In a third method, in operation with the consecutive tapping selection mode, in a case where a gesture operation other than the tap operation is performed for a certain period of time, the consecutive tapping selection mode is canceled. In a fourth method, in operation with the consecutive tapping selection mode, in a case where a coordinate of the first tap or a coordinate that is a predetermined distance away from the coordinate center of coordinates of a plurality of taps up to the present is operated, the consecutive tapping selection mode is canceled. Alternatively, the cancelation may be performed in a case where a predetermined hardware key included in the information processing apparatus 100 is operated.

As described above, in a situation where consecutive taps are not performed, for example, by releasing the consecutive tapping selection mode, it is possible to receive a tap operation in the normal mode.

### 5. Operation Other than Operation in Touch Panel Device

The above-described methods according to this embodiment can be applied to an operation other than the operation in the touch panel device. For example, the methods can also be applied to operations with pointing devices as follows:

click with a mouse

tap or press input with a touch pad (e.g., an operation to a device such as Magic Trac Pad made by Apple)

operation with an aerial pointing device (e.g., a general gyropointer or a motion controller of Wii or PlayStation Move)

pointing operation with a hand gesture operation (e.g., Kinect made by Microsoft)

In the above pointing devices, by determining the GUI object selected based on plural times of operations, even in a case where a selection area of the GUI object is small, the desired GUI object can be selected surely.

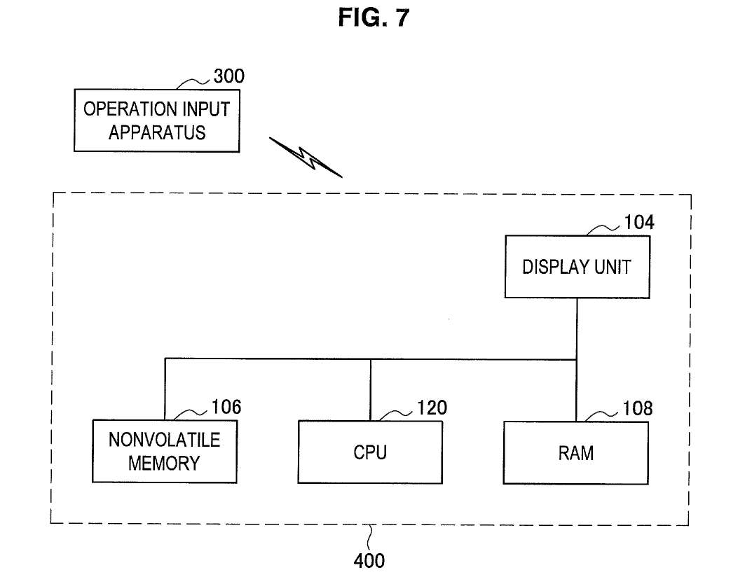

FIG. 7 is a schematic diagram showing a system that selects a GUI object with a pointing device, for example. In this case, an operation input apparatus 300 corresponds to the pointing device, and a main unit 400 includes the display unit 104, the nonvolatile memory 106, the RAM 108, and the CPU 120. The operation input apparatus 300 can designate and select the GUI object in accordance with the user's operation. The user operates the operation input apparatus 300 in a space while watching the GUI object displayed on the display unit 104, thereby performing a selection operation of the GUI object. The operation input apparatus 300 transmits information about the user's operation to the main unit 400 by wireless communication. Thus, the main unit 400 can decide the GUI object in accordance with plural times of pointing operations.

### 6. Graphic Animation

In this embodiment, it is possible to perform visual feedback using graphics. For example, during the operation with the consecutive tapping selection mode, the color of link is changed depending on the number of taps, so that the user receives the feedback. Thus, the user can know his/her operation situation and decrease erroneous selection. The visual feedback can be performed by the display processing unit 128 changing the color of link depending on the number of times counted by the counting unit 124.

As described above, according to this embodiment, the GUI object that the user is to select is decided based on the plurality of taps. Thus, even when the displayed GUI object is small, it is possible to suppress erroneous selection surely. Thus, the user can select the desired GUI object, and accuracy of the user's selection of objects can be enhanced.

It should be understood by those skilled in the art that various modifications, combinations, sub-combinations and alterations may occur depending on design requirements and other factors insofar as they are within the scope of the appended claims or the equivalents thereof.

For example, in the above embodiment, the mode is switched from the normal mode to the consecutive tapping selection mode in accordance with the user's operation; however, the switching may be performed in accordance with the size of objects displayed on the display screen. For example, the mode may be switched to the consecutive tapping selection mode when the size of the object is smaller than a predetermined size. Alternatively, the mode may be switched to the consecutive tapping selection mode when the web page is for smartphones in accordance with whether the web page is for PCs or for smartphones.

Additionally, the present technology may also be configured as below:

(1) An information processing apparatus including:

a detecting unit configured to detect a plurality of selection operations with respect to an object displayed on a display screen; and

a deciding unit configured to decide an object that a user is to select, based on the plurality of selection operations.

(2) The information processing apparatus according to (1), further including:

a counting unit configured to count a number of times a specific object is selected by the selection operations,

wherein the deciding unit decides the object that the user is to select, based on the number of times counted by the counting unit.

(3) The information processing apparatus according to (2), wherein the deciding unit decides, as the object that the user is to select, an object whose number of times counted in a certain period of time is largest.
(4) The information processing apparatus according to (2), wherein the deciding unit decides, as the object that the user is to select, an object whose number of times counted reaches a predetermined value earliest.
(5) The information processing apparatus according to (1), wherein the deciding unit decides, as the object that the user is to select, an object at a position closest to an average of coordinates of the plurality of selection operations.
(6) The information processing apparatus according to (1), wherein the deciding unit decides, as the object that the user is to select, an object that is selected consecutively a predetermined number of times or more.
(7) The information processing apparatus according to (1), further including:

a mode releasing unit configured to release a mode in which an object is decided based on the plurality of selection operations to return to a normal mode in which an object is decided based on a one-time selection operation.

(8) The information processing apparatus according to (7), wherein the mode releasing unit releases the mode in a case where the selection operations are not performed in a certain period of time.
(9) The information processing apparatus according to (7), wherein the mode releasing unit releases the mode in a case where an operation other than the selection operations is performed.
(10) The information processing apparatus according to (7), wherein the mode releasing unit releases the mode in a case where an operation is performed at a position away from a coordinate center of the plurality of selection operations by a predetermined distance or more.
(11) The information processing apparatus according to (2), further including:

a display processing unit configured to perform processing for displaying the object on the display screen,

wherein the display processing unit changes a display state of the object that is specific, in accordance with an increase in number of times the specific object is selected.

(12) The information processing apparatus according to (1), wherein the deciding unit decides the object that the user is to select, by weighting, among the plurality of selection operations, a first selection operation highly compared with other selection operations.
(13) An information processing method including:

detecting a plurality of selection operations with respect to a given object on a display screen; and

deciding an object that a user is to select, based on the plurality of selection operations.

(14) A program causing a computer to execute:

detecting a plurality of selection operations with respect to a given object on a display screen; and

deciding an object that a user is to select, based on the plurality of selection operations.

(15) An information processing system including:

a first device configured to detect an operation of a user; and

a second device including
a detecting unit configured to detect a plurality of selection operations with respect to a given object on a display screen by acquiring operation information of the user from the first device, and
a deciding unit configured to decide an object that the user is to select, based on the plurality of selection operations.

What is claimed is:

1. An information processing apparatus comprising:
an operation detecting unit configured to detect a plurality of selection operations with respect to an object displayed on a display screen; and
a deciding unit configured to decide an object that a user is to select, based on the plurality of selection operations.

2. The information processing apparatus according to claim 1, further comprising:
a counting unit configured to count a number of times a specific object is selected by the selection operations,
wherein the deciding unit decides the object that the user is to select, based on the number of times counted by the counting unit.

3. The information processing apparatus according to claim 2, wherein the deciding unit decides, as the object that the user is to select, an object whose number of times counted in a certain period of time is largest.

4. The information processing apparatus according to claim 2, wherein the deciding unit decides, as the object that the user is to select, an object whose number of times counted reaches a predetermined value earliest.

5. The information processing apparatus according to claim 1, wherein the deciding unit decides, as the object that the user is to select, an object at a position closest to an average of coordinates of the plurality of selection operations.

6. The information processing apparatus according to claim 1, wherein the deciding unit decides, as the object that the user is to select, an object that is selected consecutively a predetermined number of times or more.

7. The information processing apparatus according to claim 1, further comprising:
a mode releasing unit configured to release a mode in which an object is decided based on the plurality of selection operations to return to a normal mode in which an object is decided based on a one-time selection operation.

8. The information processing apparatus according to claim 7, wherein the mode releasing unit releases the mode in a case where the selection operations are not performed in a certain period of time.

9. The information processing apparatus according to claim 7, wherein the mode releasing unit releases the mode in a case where an operation other than the selection operations is performed.

10. The information processing apparatus according to claim 7, wherein the mode releasing unit releases the mode in a case where an operation is performed at a position away from a coordinate center of the plurality of selection operations by a predetermined distance or more.

11. The information processing apparatus according to claim 2, further comprising:
a display processing unit configured to perform processing for displaying the object on the display screen,
wherein the display processing unit changes a display state of the object that is specific, in accordance with an increase in number of times the specific object is selected.

12. The information processing apparatus according to claim 1, wherein the deciding unit decides the object that the user is to select, by weighting, among the plurality of selection operations, a first selection operation highly compared with other selection operations.

13. An information processing method comprising:
detecting a plurality of selection operations with respect to a given object on a display screen; and
deciding an object that a user is to select, based on the plurality of selection operations.

14. A program causing a computer to execute:
detecting a plurality of selection operations with respect to a given object on a display screen; and
deciding an object that a user is to select, based on the plurality of selection operations.

15. An information processing system comprising:
a first device configured to detect an operation of a user; and
a second device including
an operation detecting unit configured to detect a plurality of selection operations with respect to a given object on a display screen by acquiring operation information of the user from the first device, and
a deciding unit configured to decide an object that the user is to select, based on the plurality of selection operations.
